(19) United States
(12) Patent Application Publication
(10) Pub. No.: US 2026/0298666 A1
(43) Pub. Date: Oct. 1, 2026

(54) METHOD FOR OPERATING A GYROSCOPE SENSOR SYSTEM AND GYROSCOPE SENSOR SYSTEM

(71) Applicant: Robert Bosch GmbH, Stuttgart (DE)

(72) Inventor: Jing Liu, Bad Homburg Vor Der Hoehe (DE)

(21) Appl. No.: 19/465,317

(22) Filed: Jan. 30, 2026

(30) Foreign Application Priority Data
Feb. 4, 2025 (DE) 10 2025 104 066.4

(51) Int. Cl. G01C 25/00; G01C 19/32

(52) U.S. Cl. CPC G01C 25/00; G01C 19/32

(57) ABSTRACT

A computer-implemented method for operating a gyroscope sensor system. The method includes: receiving sensor values of a gyroscope sensor of the gyroscope sensor system; ascertaining an angular rate of the gyroscope sensor by applying a Kalman filter to the sensor values of the gyroscope sensor; and ascertaining, by a calibration algorithm, a gyroscope offset of the gyroscope sensor based on the angular rate of the gyroscope sensor ascertained by the Kalman filter. A gyroscope sensor system is also described.

### CROSS REFERENCE

The present application claims the benefit under 35 U.S.C. § 119 of Germany Patent Application No. DE 10 2025 104 066.4 filed on Feb. 4, 2025, which is expressly incorporated herein by reference in its entirety.

### FIELD

The present disclosure relates to a method for operating a gyroscope sensor system and to a gyroscope sensor system.

### BACKGROUND INFORMATION

Certain methods for operating gyroscope sensor systems and gyroscope sensor systems are described in the related art.

### SUMMARY

It is an object of the present disclosure to provide an improved method for operating a gyroscope sensor system and a gyroscope sensor system.

The object may be achieved by a method and the gyroscope sensor system of the present disclosure. Advantageous embodiments are disclosed herein.

According to one aspect, a computer-implemented method for operating a gyroscope sensor system is provided. According to an example embodiment, the method comprises:
receiving sensor values of a gyroscope sensor of the gyroscope sensor system;
ascertaining an angular rate of the gyroscope sensor by applying a Kalman filter to the sensor values of the gyroscope sensor;
ascertaining, by means of a calibration algorithm, a gyroscope offset of the gyroscope sensor based on the angular rate of the gyroscope sensor ascertained by the Kalman filter.

This can achieve the technical advantage that an improved method for operating a gyroscope sensor system can be provided. The gyroscope sensor system comprises at least one gyroscope sensor, a Kalman filter, and a calibration algorithm. The Kalman filter is used to ascertain or predict angular rates of the gyroscope sensor based on sensor values of the gyroscope sensor. Based on the angular rates of the Kalman filter, the calibration algorithm then ascertains a gyroscope offset of the gyroscope sensor. By means of the Kalman filter, more accurate angular rates can be ascertained, based on the sensor values of the gyroscope sensor, which comprise the raw values of the gyroscope sensor, than would be possible solely on the basis of the sensor values of the gyroscope sensor, since these may be affected by measurement errors and/or noise, whereas a Kalman filter operates recursively on streams of noisy input data to generate a statistically optimal estimate of the underlying system angular rate.

By applying the Kalman filter separately from the calibration algorithm, it can be explicitly configured to ascertain angular rates of the gyroscope sensor based on the sensor values of the gyroscope sensor. The calibration algorithm can be explicitly configured to calculate the gyroscope offset of the gyroscope sensor based on the angular rates of the Kalman filter.

According to one example embodiment, the method further comprises:
ascertaining, by means of the calibration algorithm, a calibrated angular rate based on the angular rate ascertained by the Kalman filter and on the gyroscope offset.

This can achieve the technical advantage that the gyroscope sensor system can be calibrated in that the calibration algorithm provides a calibrated angular rate. The calibrated angular rate is calculated based on the angular rate ascertained by the Kalman filter and on the gyroscope offset. This can bring about precise operation of the gyroscope sensor system.

According to one example embodiment, the calibrated angular rate is defined as a difference between the raw angular rate measured by a gyroscope sensor and the gyroscope offset.

This can achieve the technical advantage that a precise ascertainment of the calibrated angular rate is made possible.

According to one example embodiment, the gyroscope offset is ascertained based on the angular rate ascertained by the Kalman filter and on a gyroscope offset ascertained at an earlier time.

This can achieve the technical advantage that a precise ascertainment of the gyroscope offset is made possible. For this purpose, the gyroscope offset is calculated taking into account the angular rate ascertained by the Kalman filter and a gyroscope offset ascertained at an earlier time, for example at the most recent timestamp. By taking into account the preceding gyroscope offset, the calculation of the gyroscope offset can be adapted to the operation of the gyroscope sensor system at the last timestamp.

According to one example embodiment, the gyroscope offset and the angular rate ascertained by the Kalman filter are correlated with one another using a weighting factor, wherein the weighting factor describes a dependency between the gyroscope offset and the previous gyroscope offset and the current angular rate.

This can achieve the technical advantage that the weighting factor allows for a weighted coupling of the gyroscope offset to the angular rate currently calculated by the Kalman filter and to the previous gyroscope offset at the last timestamp. Depending on the particular weighting factor to be selected, the gyroscope offset to be calculated can be more strongly coupled to the previous gyroscope offset at the last timestamp or more strongly coupled to the current angular rate. This allows for a precise ascertainment of the gyroscope offset.

According to one example embodiment, the method further comprises:
ascertaining, based on the sensor values, that the gyroscope sensor system is in a predefined state, wherein the gyroscope offset is ascertained by means of the calibration algorithm taking into account predefined calibration parameters for the predefined state, and/or wherein the predefined calibration parameters comprise the weighting factor, and/or wherein the gyroscope offset is defined for the predefined state, and/or wherein the predefined state of the gyroscope sensor system is a static state, and/or wherein it is ascertained that the system is in the predefined state if the sensor values and associated first-order derivatives of the sensor values of the gyroscope sensor fall below a predefined limit value.

This can achieve the technical advantage that the ascertainment of the gyroscope offset can be coupled to the current state of the gyroscope sensor system. Depending on the particular state of the gyroscope sensor system, corresponding calibration parameters adapted to the particular state can be used by the calibration algorithm to ascertain the gyroscope offset.

This allows for precise adjustment of the particular gyroscope offset to the current state of the gyroscope sensor system. The current state can in particular be a static state, so that the gyroscope offset is calculated primarily when the gyroscope sensor system behaves statically.

According to one example embodiment, the method further comprises:
ascertaining that the gyroscope offset reaches or exceeds a predefined limit value;
resetting the gyroscope offset to a reset value and carrying out the method again.

This can achieve the technical advantage of preventing the gyroscope offset from deviating too far from the actual offset value, for example due to erroneous measurements or calculations. This can ensure error-free operation of the gyroscope sensor system.

According to one aspect of the present disclosure, a gyroscope sensor system is provided having at least one gyroscope sensor and a calibration system having a Kalman filter and a calibration algorithm, wherein the calibration system is configured to carry out the method for operating a gyroscope sensor system according to one of the above-described embodiments.

This can provide an improved gyroscope sensor system that is configured to carry out the method according to the present disclosure for operating a gyroscope sensor system having the aforementioned technical advantages.

According to one aspect of the present disclosure, a computing unit is provided, which is configured to carry out the method for operating a gyroscope sensor system according to one of the above-described embodiments.

According to one aspect of the present disclosure, a computer program product is provided, comprising commands that, when the program is executed by a data processing unit, cause the data processing unit to carry out the method for operating a gyroscope sensor system according to one of the above-described embodiments.

Example embodiments of the present disclosure are described with reference to the figures.

### BRIEF DESCRIPTION OF THE DRAWINGS

FIG. 1 is a schematic representation of a gyroscope sensor system according to one example embodiment.

FIG. 2 is a flowchart of a method for operating a gyroscope sensor system according to one example embodiment.

FIG. 3 is a further flowchart of the method for operating a gyroscope sensor system according to a further example embodiment.

FIG. 4 shows graphs a)-d) of calibration results.

FIG. 5 is a schematic representation of a computer program product, according to an example embodiment.

### DETAILED DESCRIPTION OF EXAMPLE EMBODIMENTS

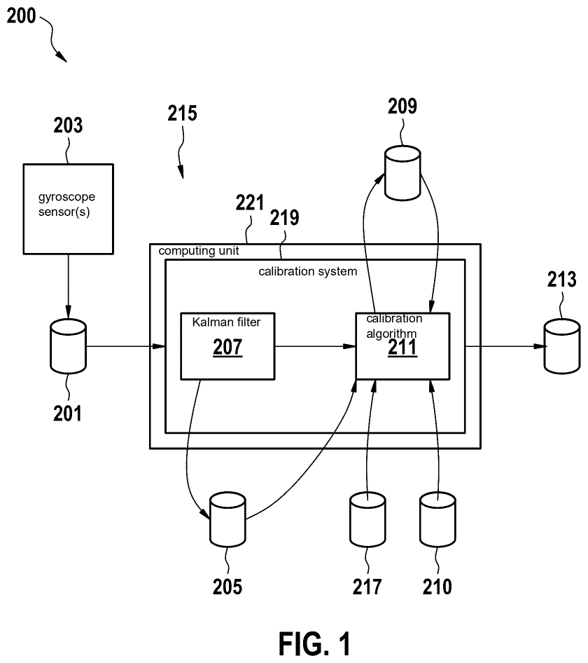

FIG. 1 is a schematic representation of a gyroscope sensor system 200 according to one embodiment.

According to the present disclosure, the gyroscope sensor system 200 comprises at least one gyroscope sensor 203, a Kalman filter 207 and a calibration algorithm 211.

In the embodiment shown, the Kalman filter 207 and the calibration algorithm 211 are independent components of a calibration system 219. The calibration system 219 is executable on a computing unit 221 of the gyroscope sensor system 200.

In order to operate the gyroscope sensor system 200, sensor values 201 of the gyroscope sensor 203 are first received by the calibration system 219. The sensor values 201 can comprise raw data from the gyroscope sensor 203. The raw data can comprise, for example, angular velocities of the gyroscope sensor 203.

Based on the sensor values 201, the Kalman filter 207 ascertains a current angular rate 205 of the gyroscope sensor 203.

Based on the sensor data 201, the Kalman filter 207 thus calculates the current angular rate 205 and provides it to the calibration algorithm 211.

In this case, the calibration algorithm 211 is configured to calculate a gyroscope offset 209 based on the current angular rate 205 of the Kalman filter 207.

Furthermore, the calibration algorithm 211 can be configured to calculate a calibrated angular rate 213 based on the raw angular rate 201 measured by the gyroscope sensor 203 and on the ascertained gyroscope offset 209.

The calibrated angular rate 213 can be defined here as a difference between the raw angular rate 201 measured by the gyroscope sensor 203 and the gyroscope offset 209:

ω₂₁₃=ω₂₀₁−ω₂₀₉

According to one embodiment, the gyroscope offset 209 can be ascertained by means of the calibration algorithm 211 based on the angular rate 205 ascertained by the Kalman filter 207 and on a gyroscope offset 210 at the last timestamp. The previous gyroscope offset 210 was ascertained by means of the calibration algorithm 211 at an earlier time according to the method steps described above. Alternatively, the previous gyroscope offset 210 can be pre-stored in the calibration system 219.

According to one embodiment, the gyroscope offset 209 and the angular rate 205 ascertained by the Kalman filter 207 are correlated with one another using a weighting factor. In this case, the weighting factor describes a dependency between the gyroscope offset 209 and the previous gyroscope offset 210 and the current angular rate 205.

ω₂₀₉=(1−α)ω₂₁₀+αω₂₀₅

where ω₂₀₉ represents the gyroscope offset 209, ω₂₁₀ represents the last gyroscope offset 210 and ω₂₀₅ represents the angular rate 205 ascertained by the Kalman filter. The factor α here is the weighting factor already mentioned.

In the embodiment shown, the gyroscope sensor system 200 is in a predefined state 215.

According to one embodiment, the calibration system 219 is configured to ascertain the particular state of the gyroscope sensor system 200 based on the sensor values 201 of the gyroscope sensor 203 and to calculate the gyroscope offset 209 primarily when the gyroscope sensor system 200 is in a predefined state 215.

The predefined state 215 can, for example, be a static state in which the gyroscope sensor 203 is not exposed to any external acceleration forces other than Earth's gravitational acceleration field.

If the gyroscope sensor system 200 is in the predefined state 215, the gyroscope offset 209 is ascertained according to the method steps described above based on the sensor values 201. To this end, the gyroscope offset 209 can be limited to or adjusted to the predefined state 215.

For example, the gyroscope offset 209 determined in this way can be predefined as a static offset.

In this case, the calibration algorithm 211 can be configured to calculate the gyroscope offset 209 for the predefined state 215 based on predefined calibration parameters for the predefined state 215. These predefined calibration parameters can, for example, comprise at least the weighting factor α, by means of which the correlation of the gyroscope offset 209 with the current angular rate 205 and the last gyroscope offset 210 (gyroscope offset 210 of the last timestamp) is established.

The fact that the gyroscope sensor system 200 is in the predefined state 215 can be ascertained, for example, by relating the first-order derivative of the sensor values 201 of the gyroscope sensor 203 to a predefined limit value.

If the current sensor values 201 of the gyroscope sensor 203, which comprise, for example, the angular velocity of the gyroscope sensor, fall below a predefined limit value, i.e., if the angular velocity is less than the predefined limit value, then the static state of the gyroscope sensor system 200 can be ascertained.

According to one embodiment, current sensor values 201 are constantly provided by the gyroscope sensor 203 during the operation of the gyroscope sensor system 200. The Kalman filter 207 calculates the current angular rate 205 based on the current sensor values 201 and provides this to the calibration algorithm 211.

Based on the current angular rate 205 and taking into account the last gyroscope offset 210, the calibration algorithm 211 calculates the current gyroscope offset 209 according to the steps described above. The gyroscope offset 209 can therefore be constantly updated during the operation of the gyroscope sensor system 200.

According to the embodiment already mentioned, the calculation of the gyroscope offset 209 can be limited to the presence of the predefined state 215, for example the static state, of the gyroscope sensor system 200. According to a further embodiment, the currently calculated gyroscope offset 209 can be compared to a predefined limit value for the particular predefined state 215.

If the currently calculated gyroscope offset 209 exceeds this predefined limit value, the gyroscope offset 209 can be reset and the calculation of the gyroscope offset 209 can be performed again. This can prevent excessive deviation of the gyroscope offset 209 from a predefined offset range for the predefined state 215.

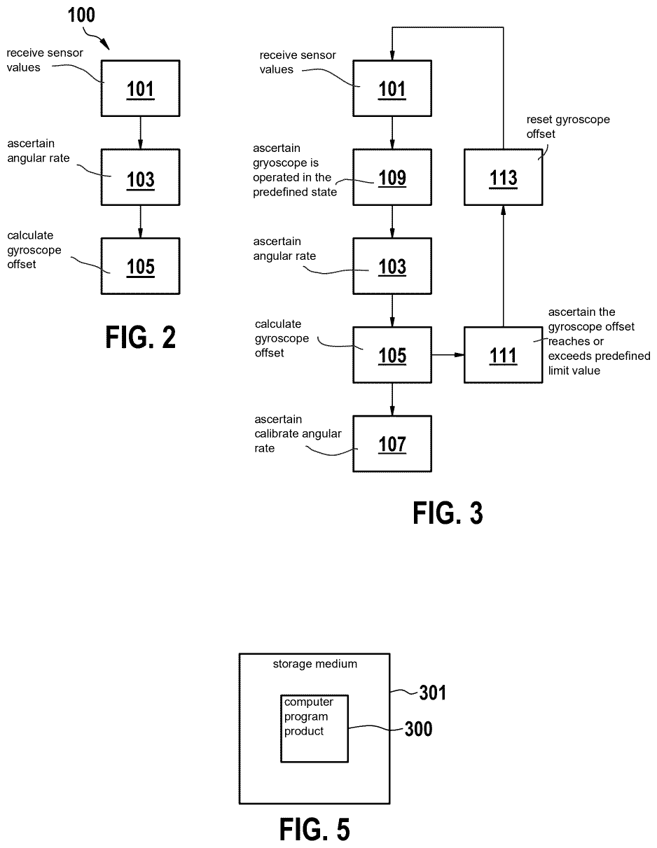

FIG. 2 is a flowchart of a method 100 for operating a gyroscope sensor system 200 according to one embodiment.

In order to operate the gyroscope sensor system, in a first method step 101, the sensor values 201 of the gyroscope sensor 203 are first received.

In a further method step 103, the angular rate 205 is ascertained by the Kalman filter 207 based on the sensor values 201 of the gyroscope sensor 203.

In a further method step 105, the gyroscope offset 209 is calculated by means of the calibration algorithm 211 based on the angular rate 205 provided by the Kalman filter 207 and on the preceding gyroscope offset 210.

FIG. 3 is a further flowchart of the method 100 for operating a gyroscope sensor system 200 according to a further embodiment.

The embodiment in FIG. 3 is based on the embodiment in FIG. 2 and comprises all the method steps described there. In the embodiment shown, in a method step 109, it is ascertained based on the sensor values 201 that the gyroscope sensor system 200 is operated in the predefined state 215.

In this case, the gyroscope offset 209 is ascertained by means of the calibration algorithm 211 taking into account predefined calibration parameters 217 for the predefined state 215. The calibration parameters 217 can comprise at least the weighting factor α.

The predefined state 215 can in particular be a static state of the gyroscope sensor system 200.

In the embodiment shown, the calibrated angular rate 213 is further ascertained in a method step 107. The calibrated angular rate 213 can be defined here as a difference between the raw angular rate 201 measured by the gyroscope sensor 203 and the previously calculated gyroscope offset 209.

In a method step 111, it can also be ascertained that the gyroscope offset 209 ascertained by means of the calibration algorithm 211 reaches or exceeds a predefined limit value.

Following this, in a method step 113, the gyroscope offset 209 is reset to a reset value. The calculation of the gyroscope offset 209 is then performed again.

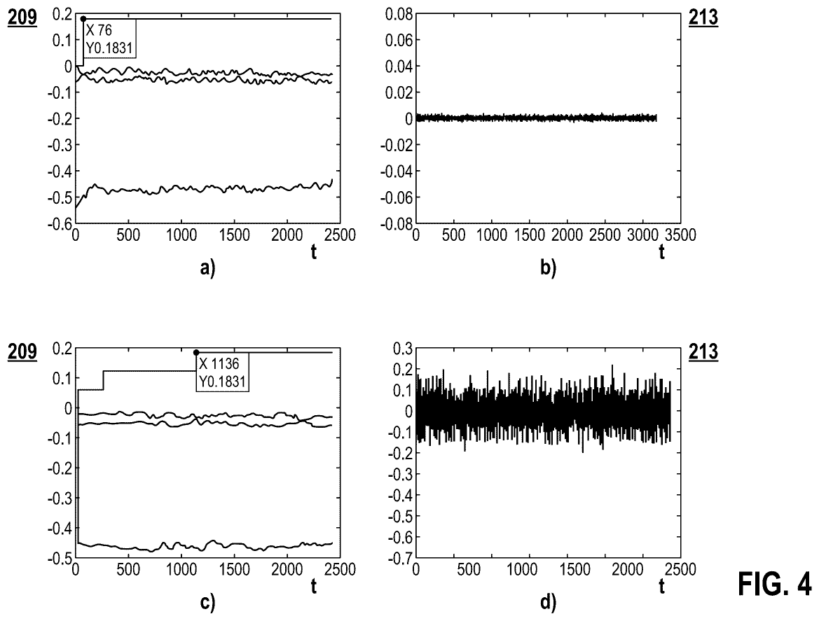

FIG. 4 shows graphs of calibration results.

Graphs a) and b) show calibration results according to the present method. Graph a) shows the time course of the calibration offset 209. Graph b) shows the time course of the calibrated angular rate 213.

In comparison, graphs c) and d) show calibration results according to a conventional method from the related art. Graph c) shows the temporal evolution of the gyroscope offset, while graph d) shows the temporal evolution of the calibrated angular rate.

As can be seen from graphs a) to d), the method according to the present disclosure demonstrates a substantially higher accuracy and stability of the calculated gyroscope offsets 209 and calibrated angular rates 213.

On average, the proposed method allows the calibration of the gyroscope sensor system 200 to be completed within 0.34 seconds with a calibration accuracy of ±1.6×10⁻⁵ degrees/seconds.

FIG. 5 is a schematic representation of a computer program product 300, comprising commands that, when the program is executed by a data processing unit, cause the data processing unit to carry out the method 100 for operating a gyroscope sensor system 200.

In the embodiment shown, the computer program product 300 is stored on a storage medium 301. Here, the storage medium 301 can be any storage medium from the related art.

What is claimed is:

1. A computer-implemented method for operating a gyroscope sensor system, the method comprising the following steps:
receiving sensor values of a gyroscope sensor of the gyroscope sensor system, wherein the sensor values represent a raw angular rate of the gyroscope sensor;
ascertaining an angular rate of the gyroscope sensor by applying a Kalman filter to the sensor values of the gyroscope sensor; and
ascertaining, using a calibration algorithm, a gyroscope offset of the gyroscope sensor based on the angular rate of the gyroscope sensor ascertained by the Kalman filter.

2. The method according to claim 1, further comprising:
ascertaining, using the calibration algorithm, a calibrated angular rate based on the raw angular rate measured by the gyroscope sensor and based on the gyroscope offset.

3. The method according to claim 2, wherein the calibrated angular rate is defined as a difference between the raw angular rate measured by the gyroscope sensor and the gyroscope offset.

4. The method according to claim 1, wherein the gyroscope offset is ascertained based on the angular rate ascertained by the Kalman filter and on a previous gyroscope offset ascertained at an earlier time.

5. The method according to claim 4, wherein the gyroscope offset and the angular rate ascertained by the Kalman filter are correlated with one another using a weighting factor, and wherein the weighting factor describes a dependency between the gyroscope offset and the previous gyroscope offset and the angular rate ascertained by the Kalman filter.

6. The method according to claim 1, further comprising:
ascertaining, based on the sensor values, that the gyroscope sensor system is in a predefined state, wherein: (i) the gyroscope offset is ascertained using the calibration algorithm taking into account predefined calibration parameters for the predefined state, and/or (ii) the gyroscope offset is ascertained using the calibration algorithm taking into account predefined calibration parameters for the predefined state, the predefined calibration parameters include the weighting factor, and/or (iii) the gyroscope offset is defined for the predefined state, and/or (iv) the predefined state of the gyroscope sensor system is a static state, and/or (v) it is ascertained that the gyroscope sensor system is in the predefined state when the sensor values and first-order derivatives of the sensor values of the gyroscope sensor fall below a predefined limit value.

7. The method according to claim 1, further comprising:
ascertaining that the gyroscope offset reaches or exceeds a predefined limit value; and
resetting the gyroscope offset to a reset value and carrying out the steps of the method again.

8. A gyroscope sensor system, comprising:
at least one gyroscope sensor; and
a calibration system including a Kalman filter and a calibration algorithm, wherein the calibration system is configured to carry out a method for operating a gyroscope sensor system, the method including the following steps:
receiving sensor values of the at least one gyroscope sensor, wherein the sensor values represent a raw angular rate of the at least one gyroscope sensor;
ascertaining an angular rate of the at least one gyroscope sensor by applying a Kalman filter to the sensor values of the at least one gyroscope sensor; and
ascertaining, using the calibration algorithm, a gyroscope offset of the at least one gyroscope sensor based on the angular rate of the at least one gyroscope sensor ascertained by the Kalman filter.

9. A device, comprising:
a computing unit configured to carry out a method for operating a gyroscope sensor system, the method comprising the following steps:
receiving sensor values of a gyroscope sensor of the gyroscope sensor system, wherein the sensor values represent a raw angular rate of the gyroscope sensor,
ascertaining an angular rate of the gyroscope sensor by applying a Kalman filter to the sensor values of the gyroscope sensor, and
ascertaining, using a calibration algorithm, a gyroscope offset of the gyroscope sensor based on the angular rate of the gyroscope sensor ascertained by the Kalman filter.

10. A non-transitory storage medium on which is stored a computer program including commands for operating a gyroscope sensor system, the commands, when executed by a data processor, causing the data processor to perform the following steps:
receiving sensor values of a gyroscope sensor of the gyroscope sensor system, wherein the sensor values represent a raw angular rate of the gyroscope sensor;
ascertaining an angular rate of the gyroscope sensor by applying a Kalman filter to the sensor values of the gyroscope sensor; and
ascertaining, using a calibration algorithm, a gyroscope offset of the gyroscope sensor based on the angular rate of the gyroscope sensor ascertained by the Kalman filter.
